(19) United States
(12) Patent Application Publication
(10) Pub. No.: US 2021/0122441 A1
(43) Pub. Date: Apr. 29, 2021

(54) Brake and Clutch side system assembly

(71) Applicant: Christopher Eder, Fairview, TX (US)

(72) Inventor: Christopher Eder, Fairview, TX (US)

(21) Appl. No.: 16/661,453

(22) Filed: Oct. 23, 2019

(51) Int. Cl. B62L 3/04; B62K 23/08; B62M 25/06

(52) U.S. Cl. CPC B62L 3/04; B62J 25/06; B62M 25/06; B62K 23/08

(57) ABSTRACT

A system including a clutch assembly to control the clutch of a vehicle and a brake side assembly to activate a brake on a vehicle,

### FIELD OF THE INVENTION

The present invention relates to brake assemblies and clutch assemblies and more particularly to a foot operated brake and clutch assembly for vehicles including motorcycles.

### BACKGROUND

Conventional motorcycles include front and rear brakes. Often, these brakes are in the form of disk brakes mounted to the respective front and rear axles. Specifically, rear brake assemblies generally include a rear disk mounted to a rear axle. The rear disk rotates with the rear wheel. Calipers or other devices apply a braking force to the rear disk brake, which in turn, provides a braking force to the rear wheel.

Most of the braking on a motorcycle is done by the front disk brake. It has been estimated that from 60% to 80% of the braking is done by the front wheel.

Also, it is typical for the front disk brake to be applied using a hand lever disposed on a handle bar and operated by a rider's hand. In contrast, the rear disk brake is typically applied by using a brake pedal operated by one of the rider's feet.

On conventional motorcycles, rear brakes are disposed coaxial with the rear wheel. In other words, the rear brake, be it a disk or drum, shares the same axis of rotation as the rear wheel. In this conventional design, the rear brake assembly moves with the rear wheel.

Likewise a motorcycle may have a standard transmission requiring changing of gears in response to the speed and torque requirements of the motorcycle. This need requires the ability to disengage the transmission while a another gear is being selected to be engaged by the transmission. The clutch assembly is usually foot controlled while the selection of the gear is achieved by a hand control mounted on the steering forks of the motorcycle.

The present invention provides a brake assembly and clutch assembly in the form of a system to control both the brakes and the clutch.

### SUMMARY

A brake side assembly to activate a brake on a vehicle may include a brake pedal configured to apply the brake in response to the user of the vehicle; a first pivoting arm connected to the brake pedal to pivot when the brake is applied by the user; a rotating shaft connected to the first pivoting arm to rotate in response to the pivoting of the first pivoting arm; a second pivoting arm connected to the rotating shaft to pivot in response to the rotating shaft; and a frame plate connected to the second pivoting arm to be mounted on the vehicle.

The brake side assembly may include a support shaft to connect the rotating shaft to the frame plate.

The vehicle may be a motorcycle.

The brake side assembly may be configured to be used with a rear brake assembly.

The frame plate may include a reservoir for brake fluid.

[symbol]

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the brake side assembly of the present invention;

FIG. 2 illustrates a perspective view of the first pivoting arm/brake arm of the brake side assembly;

FIG. 3 illustrates a perspective view of the support shaft/brake hub shaft of the brake side assembly;

FIG. 4 illustrates a cross-sectional view of the rotating shaft/brake side hub of the brake side assembly;

FIG. 5 illustrates a side view of the rotating shaft/brake side hub of the brake side assembly;

FIG. 6 illustrates a side view of the frame plate/brake side mount plate of the brake side assembly;

FIG. 7 illustrates a front view of the frame plate/brake side mount plate of the brake side assembly;

FIG. 8 illustrates a brake reserve cover of the brake side assembly;

FIG. 9 illustrates a brake hub bushing of the brake side assembly;

FIG. 10 illustrates a frame plate/brake side mount plate of the brake side assembly;

FIG. 11 illustrates a frame plate/brake side mount plate of the brake side assembly;

FIG. 12 illustrates a perspective view of the second pivoting arm/brake link arm of the brake side assembly;

FIG. 13 illustrates a perspective view of the shifter assembly of the present invention;

FIG. 14 illustrates a perspective view of the shifter side mount plate of the present invention;

FIG. 15 illustrates a perspective view of the clevis pin of the present invention;

FIG. 16 illustrates a perspective view of the clevis mount of the present invention;

FIG. 17 illustrates a perspective view of the control told peg of the present invention;

FIG. 18 illustrates a perspective view of the control foot peg of the present invention;

FIG. 19 illustrates a perspective view of the shifter bearing spacer of the present invention;

FIG. 20 illustrates a perspective view of the shifter mount plate spacer of the present invention;

FIG. 21 illustrates a perspective view of the V shaped shifter arm of the present invention;

FIG. 22 illustrates a perspective view of the shifter bearing nut of the present invention;

FIG. 23 illustrates a perspective view of the spacer of the present invention.

### DETAILED DESCRIPTION

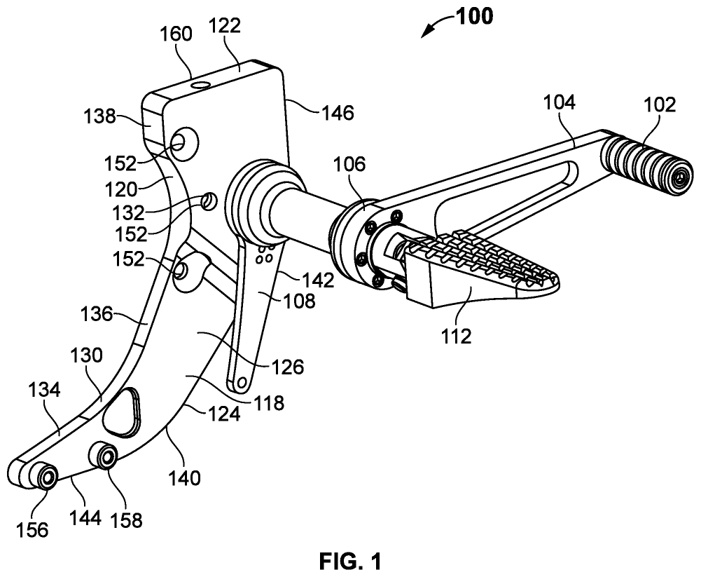

FIG. 1 illustrates a perspective view of a brake side assembly 100 which may include a brake pedal 102 which may be used by the user of the vehicle such as a motorcycle to apply pressure to the brake pedal 102 and engage the brake of the vehicle. The brake pedal 102 may be connected to a first pivoting arm/brake arm 104 which may pivot with respect to the support shaft/brake hub shaft 114 upon pressure being applied to the brake pedal 102. The support shaft 114 may be connected to a foot rest 112. The brake pedal 102 may be various shaped and is shown as a cylinder in FIG. 1. The first pivoting arm 104 may be connected to a rotating shaft/brake side hub 106 which may rotate in response to the pivoting of the first pivoting arm 104. The rotating shaft 106 may be connected to the second pivoting arm/brake link arm 108, and the second pivoting arm 108 may pivot with respect to the support shaft 114 and in response to rotation of the rotating shaft 106,

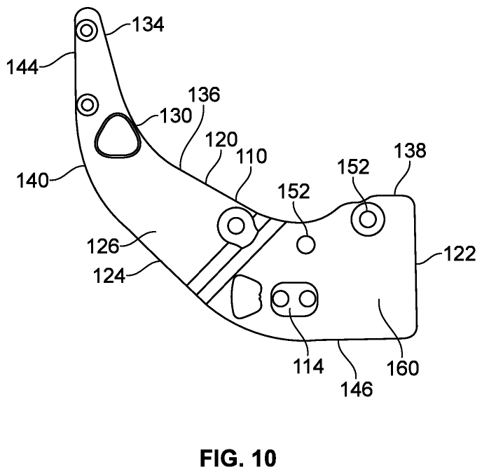

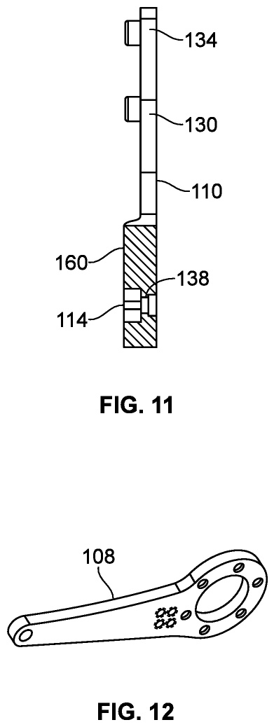

The frame plate 110 is shown in FIG. 1, FIG. 10, and FIG. 11. The support shaft 114 may be connected to the frame plate 110 which may include a front surface 120, an opposed bottom surface 124 which may be opposed to the front surface 120, a top surface 122 which may connect the front surface 120 to the bottom surface 124 and a pair of side surfaces 126 which may connect the front surface 120 to the bottom surface 124.

The front surface 120 may include a first curved front surface 130 which may be connected between the first front linear surface 134 and the second front linear surface 136, a second curved front surface 132 which may be connected between the second front linear surface 136 and the third front linear surface 138.

The back surface 126 may include a first back curved surface 140 positioned between the first back linear surface 144 and the second back linear surface 146 and the second back curved surface 142 adjacent to the first back curved surfaces 140.

The bottom surface 124 may be curved and connected between the first front linear surface 134 and the first back linear surface 144.

The top surface 122 may be substantially linear and the pair of side surfaces 126 may be substantially linear and having mounting cylinders 150 which may have a central aperture for accepting fasteners (not shown) for mounting on the vehicle and may have mounting apertures 152 for accepting fasteners (not shown) for mounting the frame plate 110 to the vehicle. The vehicle may be a Harley-Davidson motorcycle, and the mounting apertures 152 may be configured to be mounted on the Harley-Davidson motorcycle.

The frame plate 110 may include a brake reservoir 160 for brake fluid which may be enclosed by the brake reservoir cover 162 which covers and seals the brake reservoir 160.

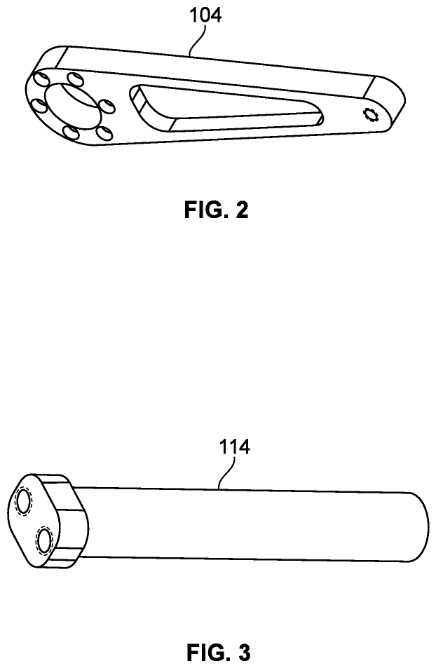

FIG. 2 illustrates a perspective view of the first pivoting arm/brake arm 104 of the brake side assembly.

FIG. 3 illustrates a perspective view of the support shaft/brake hub shaft 114 of the brake side assembly 100.

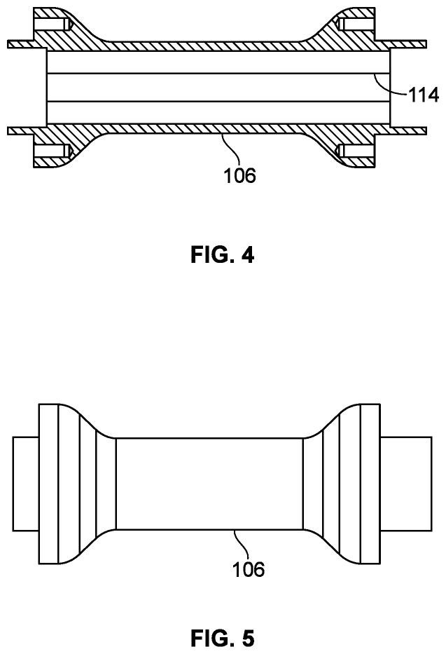

FIG. 4 illustrates a cross-sectional view of the rotating shaft/brake side hub 106 of the brake side assembly 100.

FIG. 5 illustrates a side view of the rotating shaft/brake side hub 106 of the brake side assembly 100.

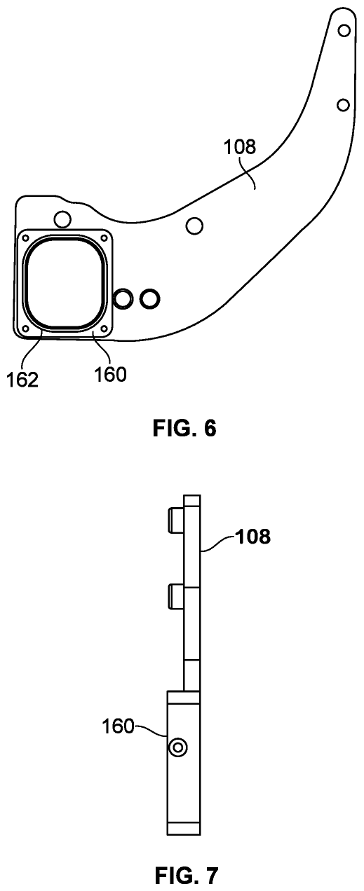

FIG. 6 illustrates a side view of the frame plate/brake side mount plate 110 of the brake side assembly 100;

FIG. 7 illustrates a front view of the frame plate/brake side mount plate 110 of the brake side assembly 100.

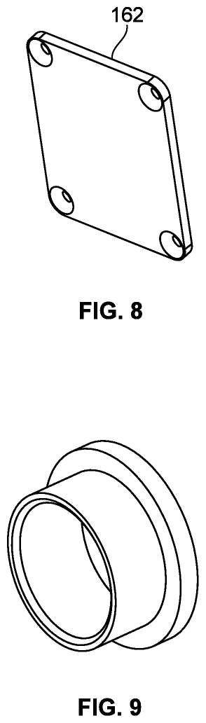

FIG. 8 illustrates a brake reserve cover 162 of the brake side assembly 100.

FIG. 9 illustrates a brake hub bushing of the brake side assembly 100.

FIG. 10 illustrates a frame plate/brake side mount plate 110 of the brake side assembly 100.

FIG. 11 illustrates a frame plate/brake side mount plate 110 of the brake side assembly 100.

FIG. 12 illustrates a perspective view of the second pivoting arm/brake link arm 108 of the brake side assembly 100.

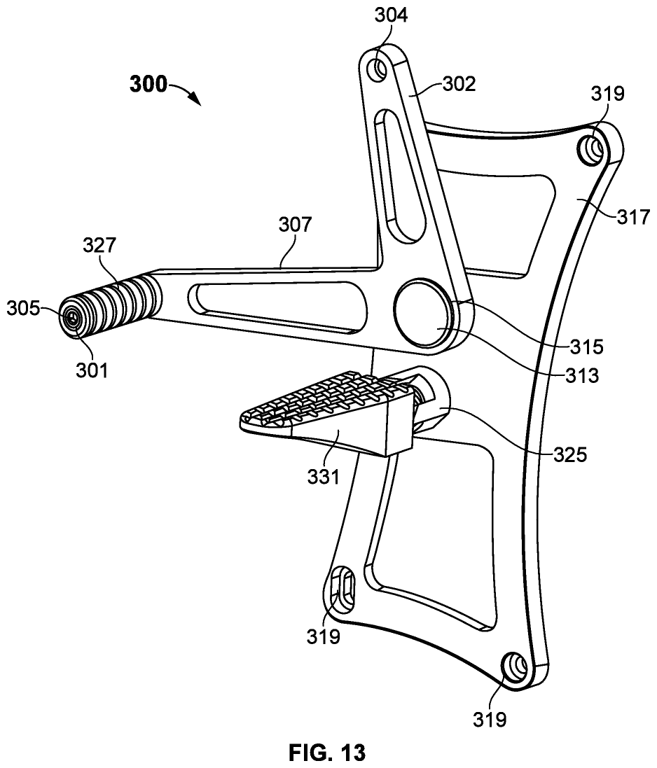

FIG. 13 illustrates a perspective view of the shifter assembly 300 of the present invention and illustrates the shifter side mount plate 317 which may include plate mounting apertures 319 which may be positioned to conform to a Harley-Davidson motorcycle. A the shape shifter arm 307 is pivotably connected to a clevis pin 313 which is connected to the V shaped shifter arm 307 which is connected to a control toe peg 327 by virtue of a spacer 301. The user may activate the clutch by applying pressure to the control toe peg 327 which in turn pivots (rotates) the V-shaped shifter arm 307. An arm 302 of the V-shaped shifter arm 307 engages and releases the clutch (not shown) by a cable (not shown) attached to an aperture 304 positioned at one end of the arm 302. Additionally, a control foot peg 331 is connected to a clevis mount 325 which is connected to the shifter side mount plate 317.

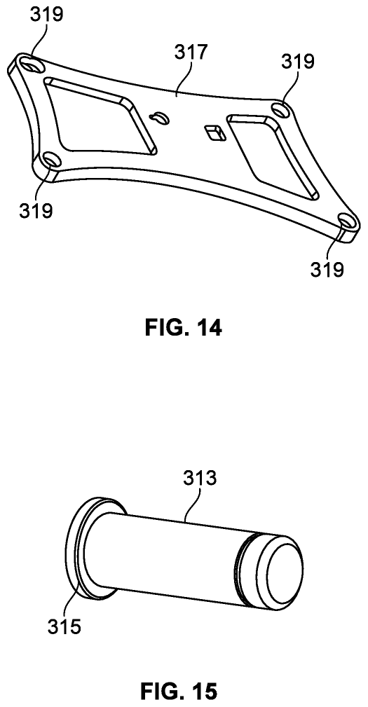

FIG. 14 illustrates a perspective view of the shifter side mount plate 317 of the present invention and shows the plate mounting apertures 319.

FIG. 15 illustrates a perspective view of the clevis pin 313 of the present invention and shows the flange 315.

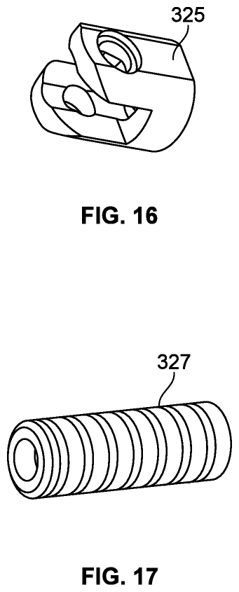

FIG. 16 illustrates a perspective view of the clevis mount 325 of the present invention.

FIG. 17 illustrates a perspective view of the control toe peg 327 of the present invention.

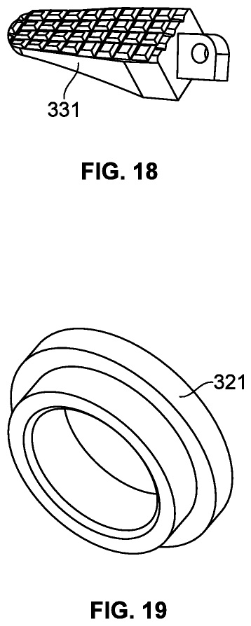

FIG. 18 illustrates a perspective view of the control foot peg 331 of the present invention;

FIG. 19 illustrates a perspective view of the shifter bearing spacer 321 of the present invention.

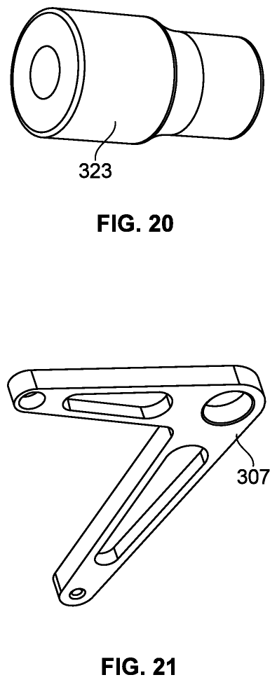

FIG. 20 illustrates a perspective view of the shifter mount plate spacer 323 of the present invention.

FIG. 21 illustrates a perspective view of the V shaped shifter arm 307 of the present invention.

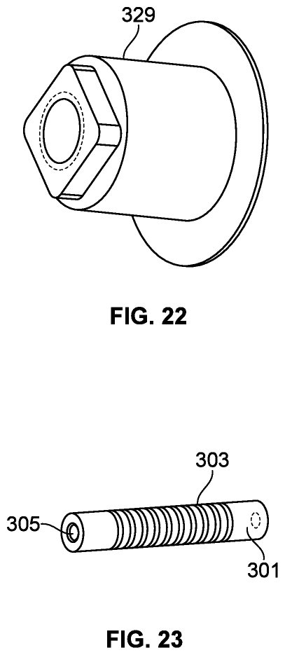

FIG. 22 illustrates a perspective view of the shifter bearing nut 329 of the present invention.

FIG. 23 illustrates a perspective view of the spacer 301 including the bridges 303 and center aperture 305 of the present invention.

The Mid Controls as described above are mounted directly to the engine/Drivetrain instead of being mounted to the frame of a motorcycle. These are mounted completely to the engine and transmission of the motorcycle.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A brake side assembly to activate a brake on a vehicle, comprising:
a brake pedal configured to apply the brake in response to the user of the vehicle;
a first pivoting arm connected to the brake pedal to pivot when the brake is applied by the user;
a rotating shaft connected to the first pivoting arm to rotate in response to the pivoting of the first pivoting arm;
a second pivoting arm connected to the rotating shaft to pivot in response to the rotating shaft;
a frame plate connected to the second pivoting arm to be mounted on the vehicle;
wherein the vehicle is a Harley-Davidson motorcycle.

2) A brake side assembly to activate a brake on a vehicle as in claim 1, wherein the brake side assembly includes a support shaft to connect the rotating shaft to the frame plate.

3) A brake side assembly to activate a brake on a vehicle as in claim 1, wherein the vehicle is a motorcycle.

4) A brake side assembly to activate a brake on a vehicle as in claim 1, wherein the brake side assembly is configured to be used with a rear brake assembly.

5) A brake side assembly to activate a brake on a vehicle as in claim 1, wherein the frame plate includes a reservoir for brake fluid.

6) A shifter assembly to control a clutch on a vehicle, comprising:
a shifter side mount plate having plate mounting apertures;
a V-shaped shifter arm being pivotably connected to the shifter side mount plate;
wherein the mounting apertures are positioned to be mounted on a Harley-Davidson motorcycle.

7) A shifter assembly to control a clutch on a vehicle as in claim 6, wherein the shifter assembly includes a control toe peg.

8) A shifter assembly to control a clutch on a vehicle as in claim 6, wherein the shifter assembly includes a control foot peg.
